(19) United States
(12) Patent Application Publication
(10) Pub. No.: US 2024/0171781 A1
(43) Pub. Date: May 23, 2024

(54) A METHOD OR AN APPARATUS FOR GENERATING FILM GRAIN PARAMETERS, A METHOD OR AN APPARATUS FOR GENERATING A BLOCK OF PIXELS WITH FILM GRAIN PATTERN

(71) Applicant: InterDigital VC Holdings France, SAS, CESSON-SEVIGNE (FR)

(72) Inventors: Milos Radosavljevic, Rennes (FR); Edouard Francois, Bourg des Comptes (FR); Christel Chamaret, Chantepie (FR); Erik Reinhard, Hede-Bazouges (FR)

(21) Appl. No.: 18/282,703

(22) PCT Filed: Mar. 15, 2022
(86) PCT No.: PCT/EP2022/056699

§ 371 Date: Sep. 18, 2023

(30) Foreign Application Priority Data
Mar. 18, 2021 (EP) 21305329.1

(51) Int. Cl. H04N 19/85; H04N 19/122; H04N 19/176; H04N 19/186

(52) U.S. Cl. CPC H04N 19/85; H04N 19/122; H04N 19/176; H04N 19/186

(57) ABSTRACT

At least a method and an apparatus are presented for efficiently processing film grain while encoding or decoding video. For example, the method comprises receiving film grain information that comprises at least one parameter that specifies an attribute of the film grain associated with an image block; applying a transform to a block of random values; filtering the transformed block, the filtering being defined by at least one parameter in the received film grain information; applying a respective inverse transform to the filtered transformed block to generate a block of pixels with film grain pattern for the image block. Advantageously, the transform is a core transform of a video coding standard, for instance one of DCT-II, DCT-VIII, DST-VII.

### TECHNICAL FIELD

At least one of the present embodiments generally relates to a method or an apparatus for film grain estimation and film grain synthesis in video coding, video distribution and video rendering, and more particularly, to a method or an apparatus for generating a block of pixels with film grain pattern for an image block.

### BACKGROUND

Film grain is often a desirable feature in video production, creating a natural appearance and contributing to the expression of creative intent. Film grain, however, does not compress well with modern video compression standards, such Versatile Video Coding (VVC) also known as ITU-T H.266 and ISO/IEC 23090-3. Indeed, within various filtering and lossy compression steps, film grain is suppressed without the possibility of reconstructing it. However, information on film grain can be communicated as metadata through for instance a SEI message specified by Versatile Supplemental Enhancement Information (VSEI, also known as ITU-T Recommendation H.274 and ISO/IEC 23002-7). Thus, the film grain is often modeled and removed prior to compression, and it is resynthesized on the decoder side with the aid of appropriate metadata. In addition, film grain can also be used as a tool to mask coding artifacts resulting from the compression. Different approaches have been studied for film grain modeling. In the context of VVC, frequency filtering solution to parametrize and resynthesize film grain can be used.

Existing methods for film grain modeling show some limitations in design complexity of film grain modeling. Therefore, there is a need to improve the state of the art.

### SUMMARY

The drawbacks and disadvantages of the prior art are solved and addressed by the general aspects described herein.

According to a first aspect, there is provided a method. The method comprises receiving film grain information that comprises at least one parameter that specifies an attribute of the film grain associated with an image block; applying a transform to a block of random values; filtering the transformed block of random values, the filtering being defined by at least one parameter in the received film grain information; and applying a respective inverse transform to the filtered transformed block to generate a block of pixels with film grain pattern for the image blocks. Advantageously, the transform is one of DCT-II, DCT-VIII, DST-VII, that is a standardized transform, for example a VVC core transform.

According to another aspect, there is provided a second method. The method comprises receiving a film grain block representative of a film grain estimate in an image block; applying a transform to film grain block; and generating at least one parameter that specifies an attribute of a film grain associated with the image block from the transformed film grain block. Advantageously, the transform is one of DCT-II, DCT-VIII, DST-VII, that is a standardized transform, for example a VVC core transform.

According to another aspect, there is provided an apparatus. The apparatus comprises one or more processors, wherein the one or more processors are configured to implement the method for generating a block of pixels with film grain pattern according to any of its variants. According to another aspect, the apparatus for generating a block of pixels with film grain pattern for an image block comprises means for receiving film grain information that comprises at least one parameter that specifies an attribute of the film grain associated with the image block; means for applying a transform to a block of random values; means for filtering the transformed block of random values, the filtering being defined by at least one parameter in the received film grain information; and means for applying a respective inverse transform to the filtered transformed block to generate a block of pixels with film grain pattern for the image block. Advantageously, the means for applying a transform implements one of DCT-II, DCT-VIII, DST-VII, that is a standardized transform, for example a VVC core transform.

According to another aspect, there is provided another apparatus. The apparatus comprises one or more processors, wherein the one or more processors are configured to implement the method for generating at least one parameter that specifies an attribute of a film grain associated with an image block according to any of its variants. According to another aspect, the apparatus for generating film grain parameters comprises means for receiving a film grain block representative of a film grain estimate in the image block; applying a transform to film grain block; and generating at least one parameter that specifies an attribute of a film grain associated with the image block from the transformed film grain block. Advantageously, the means for applying a transform implements one of DCT-II, DCT-VIII, DST-VII, that is a standardized transform, for example a VVC core transform.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a simplified block diagram of the film grain usage in a video coding/decoding framework.

FIG. 2 illustrates a simplified block diagram of a method for generating blocks of film grain pattern according to a general aspect of at least one embodiment.

FIG. 3 illustrates a modified block diagram of the film grain usage in a video coding/decoding framework according to a general aspect of at least one embodiment.

FIG. 4a illustrates a modified block diagram of a method for generating blocks of film grain pattern according to a general aspect of at least one embodiment.

FIG. 4b illustrates a modified block diagram of a method for generating film grain parameters according to a general aspect of at least one embodiment.

FIG. 5 illustrates modified block diagram of the film grain with adjustment of the film grain parameters at decoder side.

FIG. 6 illustrates a block diagram of an embodiment of video encoder in which various aspects of the embodiments may be implemented.

FIG. 7 illustrates a block diagram of an embodiment of video decoder in which various aspects of the embodiments may be implemented.

FIG. 8 illustrates a block diagram of an example apparatus in which various aspects of the embodiments may be implemented.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of an image. They may be applied to encode/decode a part of image, such as a slice or a tile, a tile group or a whole sequence of images.

Various methods are described above, and each of the methods comprises one or more steps or actions for achieving the described method. Unless a specific order of steps or actions is required for proper operation of the method, the order and/or use of specific steps and/or actions may be modified or combined.

At least some embodiments relate to method for generating a block of pixels with film grain wherein the transform used in the generating is one of DCT-II, DCT-VIII, DST-VII. The method for generating a block of pixels with film grain is for instance implemented in a video decoding scheme. At least some embodiments further relate to method for estimating and generating film grain parameters wherein the transform used in the generating is one of DCT-II, DCT-VIII, DST-VII. The method for generating film grain parameters for instance implemented in a video encoding scheme.

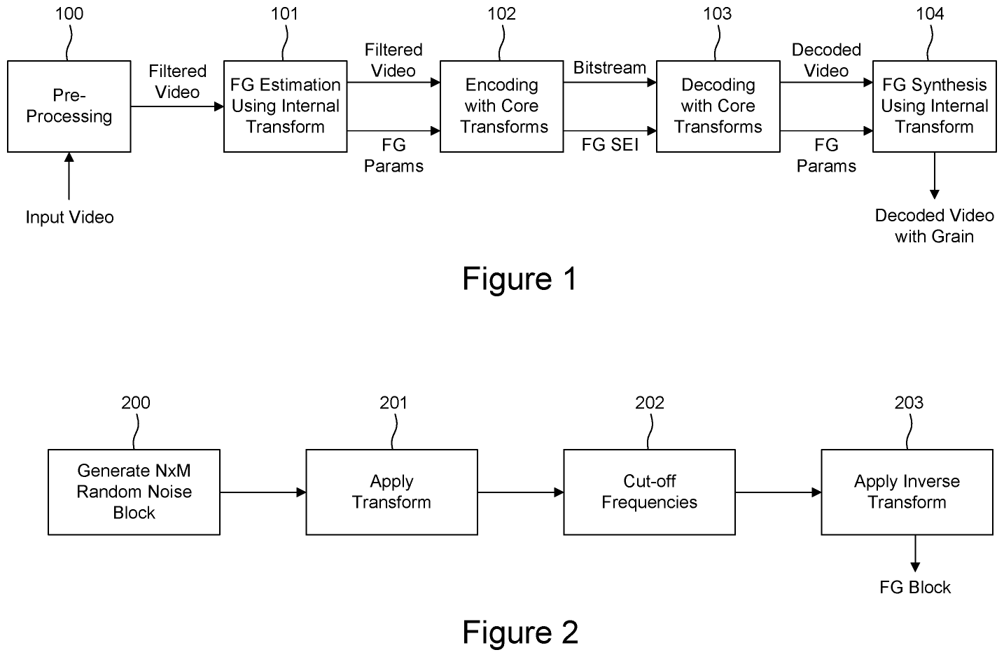

FIG. 1 illustrates a simplified block diagram of the film grain usage in a video coding/decoding framework. Film grain is a pleasant noise that enhances the natural appearance of video content. It is created during the physical process of exposure and development of photographic film. However, digital sensors do not undergo such processes and are therefore free of film grain. This generates digital video noiseless, whose perfection, clear and pronounced edges and monotonous regions can worsen the subjective experience of the viewer. Therefore, re-noising the video can improve visual experience and content creators often use it before distributing the content. This is especially accepted by movie industry, where many creators turn to the technology of adding film grain to video content to add texture and warmth to their video, or sometimes create a sense of nostalgia (e.g., to describe a previous era if narrative call for it). In addition, film grain can be used to mask compression artifacts even if it is not presented in source video.

Compression is an inevitable step in supporting the growing demands for the distribution of new content to end-users whose demands to increase the resolution and quality of the reproduced image yield huge amounts of data to be delivered. It is a huge burden for today's networks. It should therefore be noted that, prior to delivery, video is usually subjected to various pre-processing steps, where the inevitable video compression is presented. However, within the various steps of filtering and lossy compression, the film grain is suppressed without the possibility of reconstructing it. One way to alleviate this problem is to use lower quantization parameter (Qp) to better preserve fine details such as film grain. However, this can greatly increase the bitrate. Another solution is to model the film grain before compression, which can later be re-synthesized on the decoder side.

Therefore, since the film grain is considered as a desirable noise, it should be preserved during coding. This is not an easy task, because the film grain is known to have high levels at high frequencies (for example, in the DCT domain), which is usually suppressed by the quantization process. In order to preserve the look of film grain, and at the same time to improve coding efficiency, parameterized models are used to re-synthesize film grain. In addition, film grain is removed by filtering during the pre-processing step or/and suppressed by compression. Therefore, it is more efficient to use a parameterized film grain model, pre-define or estimate on-fly its parameters, remove it by various pre-processing steps and/or during the compression, and synthesize it back into video content after decompression. In this way, the film grain parameters are transmitted to the user side (decoder) via appropriate metadata, e.g., via SEI message.

The final benefits of modeling film grain are:
1) Final bitrate can be lower since we do not need strictly to preserve film grain after the compression
2) Final bitrate can be improved if film grain is filtered out before compression since it is temporally uncorrelated, so prediction can be improved
3) Visual quality of the reconstructed data is higher since we can model film grain as it was in original content (even low Qp values during the compression are going to suppress film grain)
4) Even if it was not present in original content, film grain can improve visual quality and it can mask compression artefacts

In general, film grain modeling and synthesis for video coding consists of two parts, one placed at the encoder side, and another one at the decoder side. These two parts are noise removal and parameterization at the encoder; and noise synthesis at the decoder side according to received metadata. One of the possible models for film grain parametrization and synthesis is presented in “Film Grain Technology—Specifications for H. 264|MPEG-4 AVC Bitstreams.” by Joan Llach, also known as SMPTE-RDD5. It is to note that it describes bit-accurate film grain model to add film grain to the decoded frames (hence defines film grain synthesis methodology). Nevertheless, conclusions about the encoder/parameter estimation side can be implicitly derived. A simplified block diagram of the overall process is depicted in FIG. 1. A pre-processing step 100 is first applied to the input video. The filtered video then goes through the film grain estimation 101 that uses specific internal transform implementation. This step generates film grain (FG) parameters. The video is encoded in step 102, and the FG parameters are inserted in FG SEI messages. The decoder in step 103 decodes the bitstream as well as the FG SEI messages. It generates the decoded video, that can be further enhanced in step 104 by a FG synthesis process. The transforms used in the FG estimation and synthesis process are generally specific and differ from the core transforms used in the encoding and decoding processes. Note that steps 100 and 101 can be skipped if required and replaced by fixed set of manually tuned parameters.

This disclosure complies with the presented model while improving its computational efficiency by using standardized core transform. Several transforms are part of the modern video coding standards—variants of Discrete Cosine Transform (DCT) and Discrete Sine Transform (DST)—and therefore any can be used in the proposed solution. It is beneficial to use standardized transforms for such purpose, since they are efficient by design. Also, since they are part of widely used video compression standard, many efficient software and hardware implementations are presented, and typically implemented in standard consumer equipment. It is also to note that SMPTE-RDD5 represents just one of the possible implementations of the frequency-filtering approach for film grain. However, none of them focuses on specific DCT implementation.

Thus, the model is based on the filtering in the frequency/transform domain. By this model, film grain patterns are modeled in the frequency domain by setting, or estimating on-fly, the cut-off frequencies that define a low-pass filter. Some variants support band-pass filtering, however such approach is not supported by current SEI design. It is important to note that VVC's SEI specification only provides the syntax to transmit parameters of the model, but not the methods to estimate them or how to synthesize film grain. Work in SMPTE-RDD5 provides closer look to the synthesis part. Although it is defined for H.264 standard, no modifications are needed for VVC or HEVC since both support the same metadata. The only minor modifications are needed to support bit depths higher than 8-bit.

Therefore, to simulate desired film grain pattern, two parameters are set or estimated, e.g., communicated to the synthesis part via appropriate SEI message. Those parameters represent horizontal high cut-off frequency (noted Horizontal_Cutoff) and vertical high cut-off frequency (noted Vertical_Cutoff), which in turn defines film grain pattern. Thus, each film grain pattern is synthesized using different pair of cut-off frequencies according to the frequency filtering model. If no parameters are transmitted via SEI message, one can agree upon default parameters, if synthesis part is enabled for the decoded frame.

FIG. 2 illustrates a simplified block diagram of a method for generating block of film grain patterns according to a general aspect of at least one embodiment. It begins by defining a N×M block of pseudo-random numbers that follow the Gaussian distribution in step 200. To obtain block of pseudo-random numbers, one can utilize any Gaussian random number generator already established in the literature. Block of pseudo-random numbers can be obtained on-fly, or it can be defined in advanced and stored for further use, e.g., during an initialization step. Film grain pattern is then simulated as follows.

Block b of N×M pseudo-random values, which have been generated with a normalized Gaussian distribution N(0,1), undergoes a low-pass filtering which is performed in the frequency domain by the following:

| | |
|---|---|
| 1. | Transform: B=DCT(b) (step 201) |
| 2. | Frequency filtering - low pass: (step 202) |
| | for (x=0; x<N; x++) { |
| | for (y=0; y<M; y++) { |
| | if (x>Horizontal_Cutoff ∥ y>Vertical_Cutoff) { |
| | B[x,y] = 0; |
| | } |
| | } |
| | } |
| 3. | Inverse transform: b′=Inverse_DCT(B) (step 203) |

By this, b′ represent film grain image (or block). Note that N and M can take any value, however in practice it is shown that N=M and size of 64×64 are usually employed. The previous example is described with a particular transform implementation based on a DCT, although another transform can be used, e.g., Fast Fourier Transform. Thereafter, each block b′ represents N×M film grain image that is used to add grain to the decoded frame. Different film grain patterns (for different cut-off pairs) can be pre-computed creating a database of available film grain patterns or can be calculated on-fly as each decoded frame is ready to be processed. For example, SMPTE-RDD5 specifies 64×64 integer inverse transform that is used to create a database of different film grain patterns. They propose to use LUT of transformed Gaussian pseudo-random numbers that are pre-computed during initialization step and stored for further use. At the end, additional operations may be applied after obtaining N×M film grain image, such as scaling, deblocking as described in SMPTE-RDD5. The same stands for all color components.

On the encoder side, cut-off frequencies can be estimated from real data, on-fly (includes blocks 100 and 101). This is not mandatory step, however if we want to get the original film grain look it is rather desirable to precisely estimate its parameters than to use default parameters that are defined a priori. In such case, denoising is performed first, and grain parameters are estimated strictly on a flat region of a frame based on difference of the original and noiseless (filtered) frame. Denoising/filtering can utilize any algorithm capable of reducing noise in the processed frames. Instead of performing filtering, one can utilize reconstructed image. However, in such case additional artefacts resulted from compression can interfere estimation process. Anyhow, in such way film grain patterns are obtained. For example, film grain pattern in such case is N×M residual block obtained subtracting original and filtered frame, and which is taken at the flat image region since edges and complex textures can lead to wrong estimation. Film grain patterns are then input to the transforming process, e.g., DCT, in order to receive set of transforms coefficients. By analyzing an obtained set of transformed coefficients, we can estimate the cut-off frequencies that fully describe the pattern of the film grain. Those cut-off frequencies are embedded in the bitstream via SEI messages and they are used at the decoder side to simulate film grain as previously described, for example as in SMPTE-RDD5. Note that, in order to estimate cut-off frequencies each block that represents noise image (difference between filtered and original frame) should be subjected to the transform. The transform process using custom integer approximation of DCT introduces additional calculations at the encoder side during pre-processing step and represents additional computational burden to the encoder. Thus, it is very important to introduce computational saving whenever possible. This problem is even critical when considering implementations and hardware designs of decoders.

This is solved and addressed by the general aspects described herein, which are directed to method and devices for generating a block of pixels with film grain pattern wherein the transform used in the generating is one of DCT-II, DCT-VIII, DST-VII also used as VVC core transforms. A corresponding method for estimating film grain and generating film grain parameters at encoding is also disclosed wherein the transform used in the estimating is one of DCT-II, DCT-VIII, DST-VII, i.e. VVC core transforms.

Advantageously, we note that any of the several types of DCT, but also DST, used as VVC core transforms is suitable for this algorithm. By this we can obtain, but also estimate, film grain patterns in an efficient manner for different cut-off frequencies. When it comes to efficient implementation, there are already many proposed implementations and hardware designs for VVC's core transforms. By using standardized transform for film grain we know that exact the same implementation is going to be used by many compliant devices (or vendors), and precise film grain estimation and synthesis can be performed without a fear of doing something in a different way. Interoperability among different devices is secured in this way, which may be especially important if film grain becomes mandatory part in video coding standards.

Besides by using core transforms that are already implemented in the encoder/decoder, we save of implementing another transform (DCT) in addition. Also, those 3 core transforms are optimized. Its design is efficient. They are already going to be implemented (software and/or hardware as part of encoder/decoder) and implementing another one (that is not that well designed as those 3) is just additional complexity. Especially if it needs to be design in hardware, which impose additional cost.

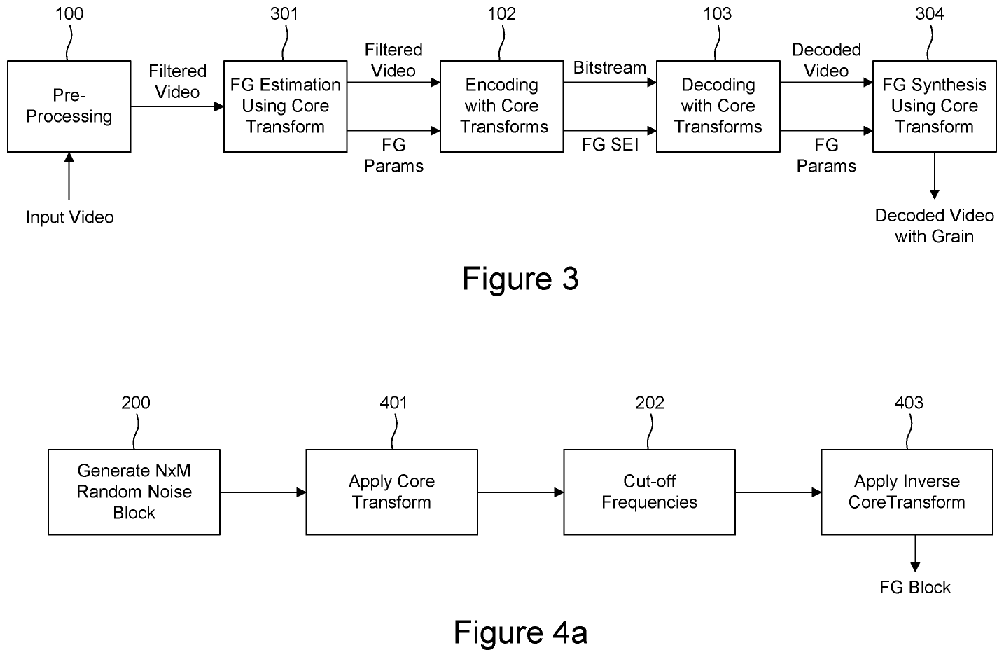

FIG. 3 illustrates a modified block diagram of the film grain usage in a video coding/decoding framework according to a general aspect of at least one embodiment.

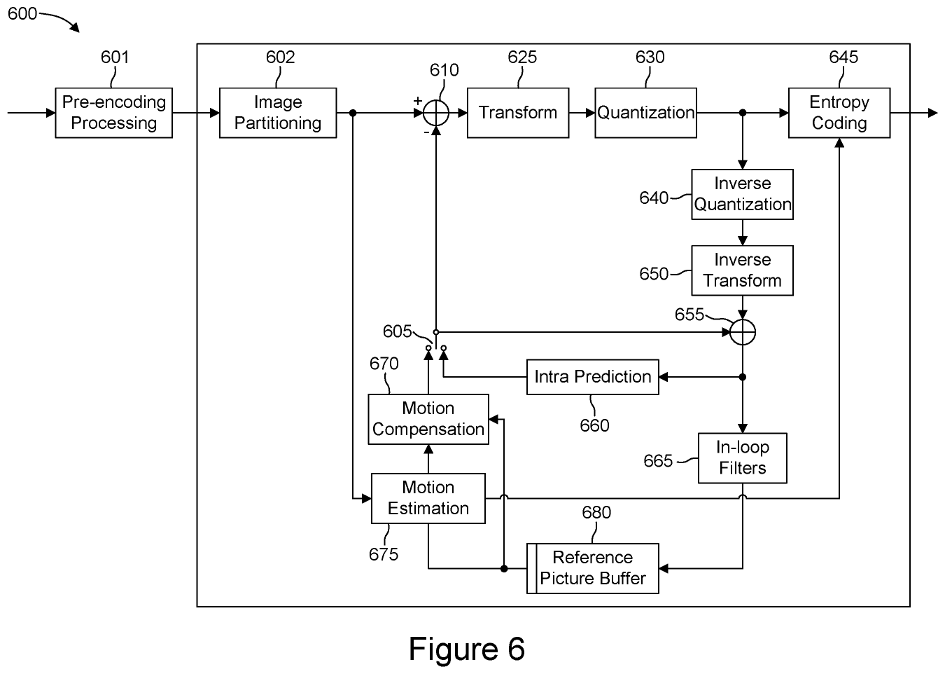

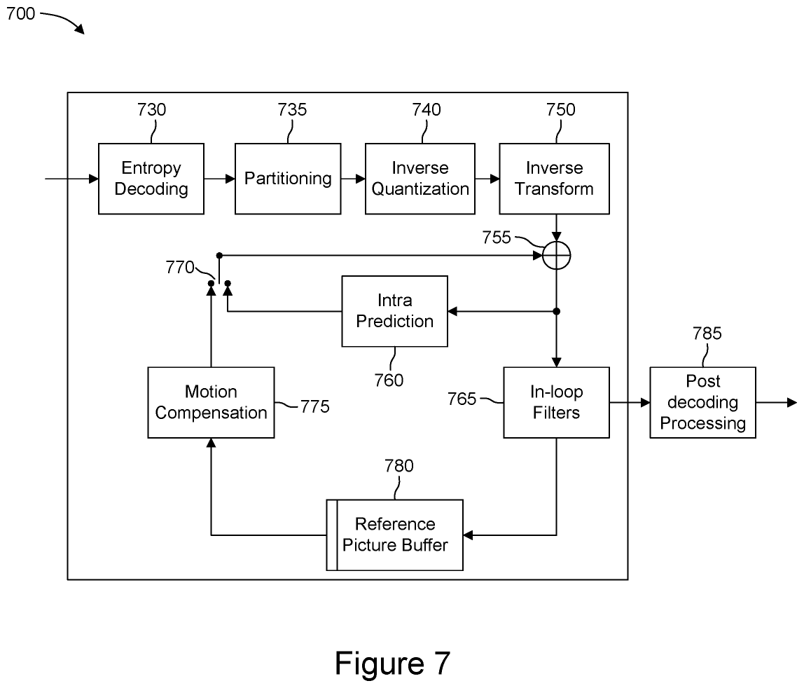

The present principles disclose to use standardized transforms on both sides (film grain estimation and synthesis). According to an embodiment, the standardized transform can be used at the encoder side, to generate information on film grain (if any present in source video), and if on-fly parameter estimation is required. According to another embodiment, fixed set of manually tuned parameters is used, in which case transform is not utilized for film grain at the encoder side. The encoding step 102 of FIG. 3 partially represents modules of an encoder or encoding method, for instance implemented in the exemplary encoder of FIG. 6. The film grain information that includes at least one parameter that specifies an attribute of the film grain to appear in the block is then embedded in the bitstream as metadata. On the decoder side, bitstream and film grain information are decoded and film grain is simulated in accordance with received metadata. The decoding step 103 of FIG. 3 partially represents modules of a decoder or decoding method, for instance implemented in the exemplary decoder of FIG. 7. Since encoder and decoder already utilize standardized transforms, their implementation in the context of film grain is straightforward. Thus, bit-accurate transform coefficients are obtained on any compliant codec. Thereafter, transformed coefficients are analyzed to obtain film grain parameters in step 301 or undergo filtering to obtain film grain image/pattern in step 304. The steps of film grain estimation 301 and film grain synthesis 304 are modified versions of steps 101 and 103, respectively, with the replacement of internal transform by the core transforms specified in the video codec.

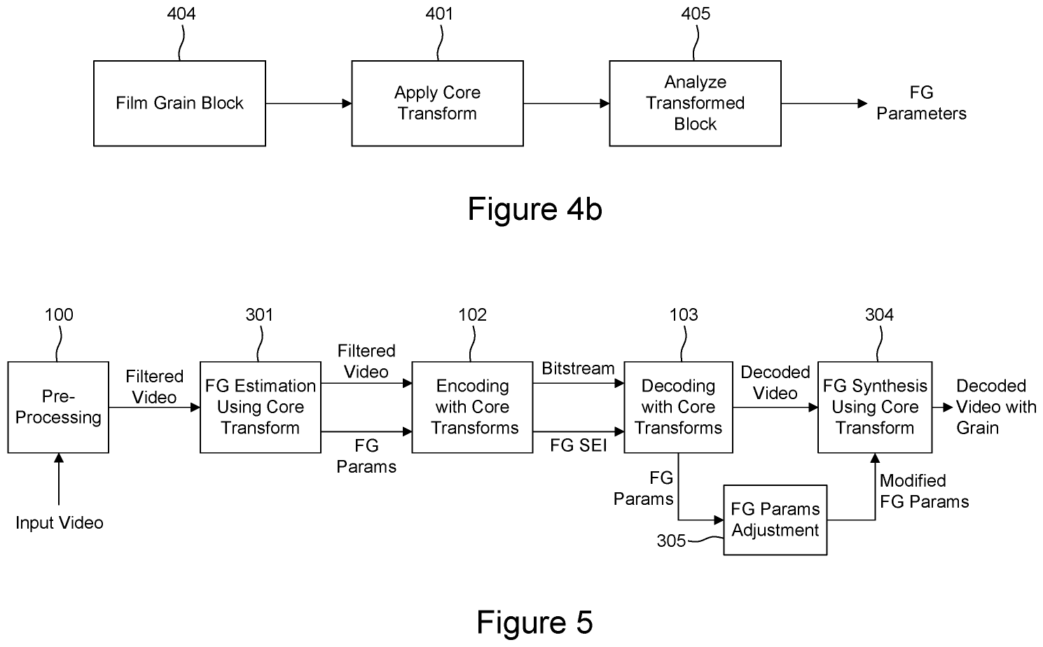

FIG. 4a illustrates a modified block diagram of a method for generating blocks of film grain pattern according to a general aspect of at least one embodiment. In a preliminary step not represented on FIG. 4a, film grain information is received where film grain information comprises at least one parameter that specifies an attribute of the film grain to appear in the block. At the decoder, film grain information comprising receiving and decoding a Supplemental Enhancement Information message containing the at least one parameter. Then, a transform, being one of DCT-II, DCT-VII, or DST-VII, is applied to a block of random values which results in a set of transform coefficients in the frequency domain also referred to as transformed block of random values. According to a non-limiting variant, in a step 200, a block of random values selected from a list of Gaussian random numbers is generated. According to non-limiting variants, the size of the block of pixels is N×M, where N is an integer in the range [2-64] and M is an integer in the range [2-64]. According to non-limiting variant, N or M are integer larger than 64, and the block size is scaled to be adapted to core transform size. As previously, to obtain block of pseudo-random numbers, one can utilize any Gaussian random number generator already established in the literature. Block of pseudo-random numbers can be obtained on-fly, or it can be defined in advanced and stored for further use, e.g., during an initialization step. Then, in a step 401, core transform is applied to the block of random values wherein the core transform is one of DCT-II, DCT-VIII, DST-VII. The transform results in a set of transform coefficients in the frequency domain. As for the step 200, the set of transform coefficients can be obtained on-fly, or it can be defined in advanced and stored for further use. Then, the coefficients of the transformed block are filtered in 202 with a low pass filter. As previously, the filtering is defined by at least one parameter in the received film grain information, representative of the cut-off frequencies, respectively for vertical and horizontal edges. In a step 403, an inverse core transform is applied to the filtered set of coefficients for the block to generate the block of pixels with film grain pattern. The inverse core transform is the inverse transform corresponding to the transform used in step 401, namely one of DCT-II, DCT-VIII, DST-VII, i.e. a standardized core transform.

When it comes to the supported transform implementations, VVC implements several types of transforms with variable sizes. It is known as Multiple Transform Selection (MTS) tool, firstly introduced in VVC. It supports:
DCT-II, block size 2×2 to 64×64, square and non-square
DCT-VIII, block size 4×4 to 32×32, square and non-square
DST-VII, block size 4×4 to 32×32, square and non-square

It is to note that abovementioned transforms are integer approximations of original floating-point transforms and are designed in a way to support efficient implementation in hardware and software.

Hence, the process of establishing a set of transformed coefficients for the purpose of film grain modeling can occur in different ways. Any combination of the above-mentioned transforms and block sizes (including non-square) is possible. Some possible embodiments are described in the following, with the indication that there may be other embodiments that are also based on the use of one (or combination of more) of the available transforms and available transform sizes.

FIG. 4b illustrates a modified block diagram of a method for estimating film grain parameters and generating the at least one parameter that specifies an attribute of a film grain associated with the image block to be used in a decoder according to a general aspect of at least one embodiment. In a preliminary step 404, film grain block is received. At the encoder, receiving film grain block is result of a pre-processing step. As previously described, to obtain film grain block, pre-processing step comprises filtering the original frame and mask derivation. Mask is used to indicate a flat region of a frame. To derive mask, one can use any method known in prior art that is capable to detect complex textures and edges. A mask excludes those non-flat regions when selecting a block on which the film grain parameters are going to be derived. A film grain block is than represented as N×M residual signal taken from flat region of a frame indicated by mask and calculated as a difference of original/input block and filtered one. Such block represents film grain estimate, which is subject to core transform 401. A transformed block is then analyzed 405 after which at least one film grain parameter is calculated and communicated to the decoder side.

Various embodiments of the generic film grain pattern generating and estimating method are described in the following.

For film grain, we can utilize one of the presented standardized DCT transforms or standardized DST transform. In VVC, the transforms are DCT-II that goes up to 64×64, and DCT-VIII and DST-VII that go up to 32×32. We can utilize different transform sizes, however it was established that square N×M transform, where N=M, gives the best performance, although this is not required solely to be so (non-square transform is supported as well in VVC and can be used instead square transform for film grain modeling). N (and M) can be any of the abovementioned supported sizes, however N,M=64 and N,M=32 provide good tradeoff between complexity and performance.

According to a particular embodiment, the same transform type and same transform size is used for luma and chroma components.

In a variant embodiment, the block size for estimating/generating the FG patterns for luma and chroma is set to 64×64 and the DCT-II specified in the VVC specification is used.

In an additional variant embodiment, the block size for estimating/generating the FG patterns for luma and chroma is set to 32×32 and the DCT-II specified in the VVC specification is used.

In an additional variant embodiment DCT-II specified in the VVC specification is used for luma and chroma components and transform size is less than 32×32.

In an additional variant embodiment, instead of DCT-II, DCT-VIII or DST-VII specified in the VVC specification can be used for estimating/generating the FG patterns for luma and chroma components by using any supported block size. For example, we use DCT-VIII or DST-VII with size of 32×32.

In an additional variant embodiment, sizes less than 32×32 are used for estimating/generating the FG patterns for luma and chroma components, in which case embodiment can use DCI-II, DCT-VIII, or DST-VII.

In all previous variant embodiments transform type and transform size are known in advanced, and no need for additional signaling is imposed. The same transform type and transform size are used for both luma and chroma components.

According to another particular embodiment, a same transform type but different transform sizes are used for luma and chroma components.

In an additional variant embodiment, for example, when the chroma format is 4:2:0 (but not strictly limited to it), the block size for generating the FG patterns for luma is set to 64×64 and for chroma is set to 32×32 and the DCT-II specified in the VVC specification is used. Hence, different transform sizes are used for luma and for chroma components. In a same manner, for example, we use DST-VII and block size 32×32 for luma and 16×16 for chroma. In here, as with previous embodiments, transform type is the same for luma and chroma, but size is different. However, block size is set in advance and no need for signaling is required. Hence, we can use DCT-II and any combination of different transform sizes for luma and chroma component. Same can be said for other transform type, e.g., DCT-VIII or DST-VII, where for example we use 32×32 block size for luma and 16×16 for chroma, or any other combination of sizes for luma and chroma.

According to a particular embodiment, different transform types but a same transform size for luma and chroma components.

In an variant embodiment, the block size for generating the FG patterns is 32×32. In this case, DCT-II, DCT-VIII or DST-VII, as defined in VVC, can be used. In this variant, the type of transform is different for luma and chroma. Also, in another variant, size is smaller than 32×32. In this case, as with previous, size and transforms are set in advance and no need for further signaling is required. Only this time, transform type is different for luma and chroma components. For instance, for FG luma blocks, DCT-II is used, while for FG chroma blocks, DCT-VIII is used. A rationale for using different transforms is that the luma and chroma noise signals may present strongly different statistics.

According to a particular embodiment, different transform types and different transform sizes are used for luma and chroma components.

In a variant embodiment, both transform size and transform type are different for luma and for chroma components. However, size and type are set in advance and no signaling is required.

According to a particular embodiment, the type and size of transform is either signaled or inferred instead of a priori defined types and sizes.

In an extension of previous embodiments, there is no need to specify the used transform in advanced. Instead, transform used for film grain estimation is selected among different transforms (by manual control, or by from content analysis) and signaled for synthesis. In another variant, transform size used to generate and estimate film grain is signaled. In another variant, both transform size and transform type are signaled. The signaling is the same for luma and for chroma components or is different (separated) for luma and for chroma components. According to an exemplary embodiment, the film grain parameters are exactly the same for all color components, hence signaled only once. In such case additional metadata indicates proposed design, for example flag that says that one set of parameters is applied for all color components.

In another variant, transform size and/or transform type are signaled for luma component only, and transform type and size for chroma are implicitly derived. For example, based on one set of parameters signaled for luma component, the set of parameters for chroma component is determined. For example, the same transform is used for chroma as for luma, which can be derived based on signaled parameters for luma component only and cutoff frequencies are down-sampled versions of the luma's cutoff frequencies.

A syntax example is provided in the table below, implementing different embodiments discussed above.

```
film_grain_information( )
  ...
  transform_type_luma
  transform_width_luma
  transform_height_luma
  same_transform_type_luma_chroma_flag
  if ( same_transform_type_luma_chroma_flag = = 0 )
    transform_type_chroma
  if ( same_transform_size_luma_chroma_flag = = 0 ) {
    transform_width_chroma
    transform_height_chroma
  }
  ...
}
```

In an additional embodiment, transform type and size are inferred for luma and for chroma. For example, the most frequent transform used to encode/decode the current frame is further used for film grain purpose. A syntax element “transform_type_luma_inferred_flag” is also inserted to indicate if the luma transform type is inferred or not. When it is not inferred, the luma transform type is signaled.

It is to note that many different variants of signaling, explicitly or implicitly derived parameters, may exist. They cannot all be listed in this disclosure, but man of art can see other various variants on this topic.

Hence, in one variant, the type of the transform used for estimating and/or generating the FG patterns is indicated by a syntax element. The same concept can apply for transform size, or even for non-square block patterns. The signaling can be done on sequence level, I-period, GOP, per frame, per CTU or per CU, which depends on particular requirements and particular implementation. Syntax elements can be inserted in an SEI message, but also in an adaptation parameter set (APS), sequence parameter set (SPS), and/or picture parameter set (PPS).

The man of art can conclude that larger transform sizes and other types are possible in the future. As video coding standards are evolving constantly, future standards may support different (larger) transform sizes and more diverse transform types. In that case, new/additional sizes and types can be applied in the same manner as described in this disclosure to estimate/generate film grain.

According to a particular embodiment, the horizontal and vertical transform type and size are adapted.

Also, VVC enables using different horizontal and vertical transform types, and rectangular transform blocks. In an embodiment, FG block patterns are generated using different horizontal and vertical transformations. In another embodiment, FG block patterns are generated using different horizontal and vertical dimensions (transform sizes). In an embodiment, the horizontal and vertical transform types are signaled. Similarly, the recommended horizontal and vertical sizes of the FG pattern blocks are signaled.

Even that only DCT-II is considered for chroma components and Luma blocks of size higher than 32, which is defined by VVC specification, it does not prevent the use of other types and sizes for the purpose of estimating and synthesizing a film grain. Film grain can be done in the pre/post processing step and the idea is to reuse available transform implementation (hardware or software), and in that case the limits of the video coding standard in terms of block sizes and available types for different color components does not apply for film grain. Also, the proposed method is compliant and can be used with any chroma subsampling format.

According to a particular embodiment, the FG parameters are scaled to block size. According to other embodiments, additional scaling of film grain parameters, e.g., cutoff frequencies, is performed. For example, if parameters are intended to be used on 64×64 block, e.g., estimated on 64×64 block, but if they are going to be used to create 32×32 film grain pattern (synthesized by using 32×32 film grain block), parameters are downscaled to match the block requirements. For example, parameters are estimated on 64×64 block at the encoder side, but needs to be used to create 32×32 film grain pattern at the decoder side, for complexity or implementation rationales. Similarly, upscaling of parameters are performed if they are set/estimated to be used on 32×32 blocks, but decoder side uses it on 64×64 block.

FIG. 5 illustrates modified block diagram of the film grain with adjustment of the film grain parameters at decoder side. A new step of FG parameters adjustment is inserted (step 305) before the FG synthesis.

According to a particular embodiment, the FG parameters adapted to transform type. Also, if required, in one embodiment FG can be estimated by using one transform type on the encoder side, and synthesized on the decoder side by using different type of transform. For example, it can be estimated by using DCT-II and FG pattern synthesis can be done using DCT-VIII transform type. In a specific embodiment, some additional adjustments can be done to support such approach. One example can be resampling of the transformed coefficients when creating FG pattern before inverse transform, since the transform is changed. Another one can be adding for example an offset (positive or negative) to the signaled cutoff frequencies to compensate different transform types.

According to a particular embodiment, core transforms from other video coding standards are used. In addition, instead of VVC transform, in an embodiment, HEVC or H.264/AVC standardized transform is used. In that case some other limitation in terms of transform size or transform types can be imposed in accordance to the standard specification.

According to a particular embodiment, type of filtering different from low pass is used. Even that this disclosure is described by using low pass filtering to model film grain pattern, man of art can conclude that in some embodiments different filtering can be used. For example, instead of low pass filtering that is represented by two cut-off frequencies as described before, one can use band pass filtering. In that case four different frequencies (vertical high cut-off, vertical low cut-off, horizontal high cut-off, and horizontal low cut-off frequency) are used to define film grain pattern. One can conclude that other filtering can be used for purpose of creating film grain pattern in frequency domain.

Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

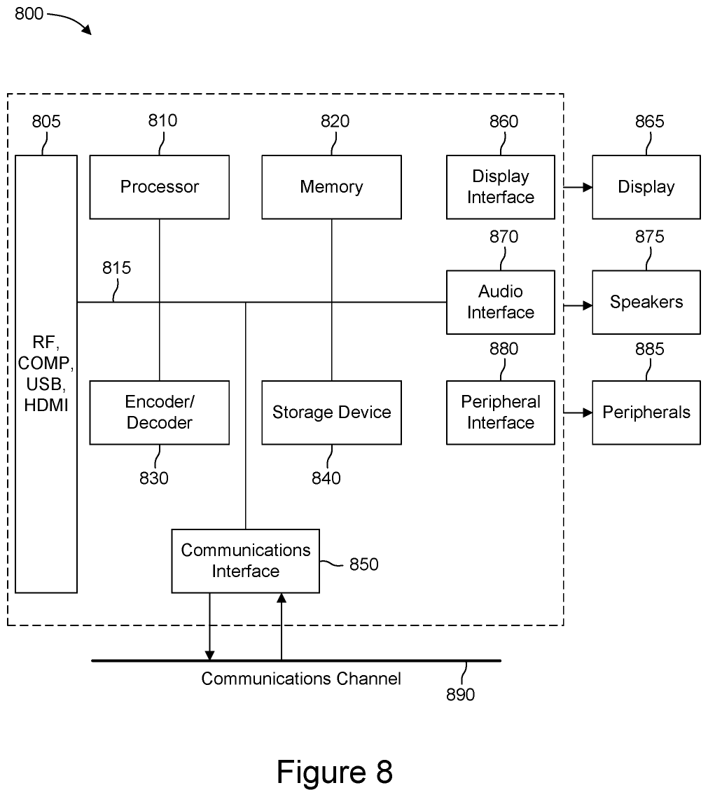

The aspects described and contemplated in this application can be implemented in many different forms. FIG. 6, FIG. 7 and FIG. 8 below provide some embodiments, but other embodiments are contemplated, and the discussion of FIG. 6, FIG. 7 and FIG. 8 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, pre-encoding processing module or post-processing decoding module (601, 785), of a video encoder 600 and decoder 700 as shown in FIG. 6 and FIG. 7. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the number of transforms, the number of transform level, the indices of transforms. The specific values are for example purposes and the aspects described are not limited to these specific values. FIG. 6 illustrates an encoder 600. Variations of this encoder 600 are contemplated, but the encoder 600 is described below for purposes of clarity without describing all expected variations.

Before being encoded, the video sequence may go through pre-encoding processing 601, for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 600, a picture is encoded by the encoder elements as described below. The picture to be encoded is partitioned 602 and processed in units of, for example, CUs. Each unit is encoded using, for example, either an intra or inter mode. When a unit is encoded in an intra mode, it performs intra prediction 660. In an inter mode, motion estimation 675 and compensation 670 are performed. The encoder decides 605 which one of the intra mode or inter mode to use for encoding the unit, and indicates the intra/inter decision by, for example, a prediction mode flag. Prediction residuals are calculated, for example, by subtracting 610 the predicted block from the original image block.

The prediction residuals are then transformed 625 and quantized 630. The quantized transform coefficients, as well as motion vectors and other syntax elements, are entropy coded 645 to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized 640 and inverse transformed 650 to decode prediction residuals. Combining 655 the decoded prediction residuals and the predicted block, an image block is reconstructed. In-loop filters 665 are applied to the reconstructed picture to perform, for example, deblocking/SAO (Sample Adaptive Offset) filtering to reduce encoding artifacts. The filtered image is stored at a reference picture buffer 680.

FIG. 7 illustrates a block diagram of a video decoder 700. In the decoder 700, a bitstream is decoded by the decoder elements as described below. Video decoder 700 generally performs a decoding pass reciprocal to the encoding pass as described in FIG. 6. The encoder 600 also generally performs video decoding as part of encoding video data.

In particular, the input of the decoder includes a video bitstream, which can be generated by video encoder 600. The bitstream is first entropy decoded 730 to obtain transform coefficients, motion vectors, and other coded information. The picture partition information indicates how the picture is partitioned. The decoder may therefore divide 735 the picture according to the decoded picture partitioning information. The transform coefficients are de-quantized 740 and inverse transformed 750 to decode the prediction residuals. Combining 755 the decoded prediction residuals and the predicted block, an image block is reconstructed. The predicted block can be obtained 770 from intra prediction 760 or motion-compensated prediction (i.e., inter prediction) 775. In-loop filters 765 are applied to the reconstructed image. The filtered image is stored at a reference picture buffer 780.

The decoded picture can further go through post-decoding processing 785, for example, an inverse color transform (e.g. conversion from YCbCr 4:2:0 to RGB 4:4:4) or an inverse remapping performing the inverse of the remapping process performed in the pre-encoding processing 601. The post-decoding processing can use metadata derived in the pre-encoding processing and signaled in the bitstream.

FIG. 8 illustrates a block diagram of an example of a system in which various aspects and embodiments are implemented. System 800 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 800, singly or in combination, can be embodied in a single integrated circuit (IC), multiple ICs, and/or discrete components. For example, in at least one embodiment, the processing and encoder/decoder elements of system 800 are distributed across multiple ICs and/or discrete components. In various embodiments, the system 800 is communicatively coupled to one or more other systems, or other electronic devices, via, for example, a communications bus or through dedicated input and/or output ports. In various embodiments, the system 800 is configured to implement one or more of the aspects described in this document.

The system 800 includes at least one processor 810 configured to execute instructions loaded therein for implementing, for example, the various aspects described in this document. Processor 810 can include embedded memory, input output interface, and various other circuitries as known in the art. The system 800 includes at least one memory 820 (e.g., a volatile memory device, and/or a non-volatile memory device). System 800 includes a storage device 840, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 840 can include an internal storage device, an attached storage device (including detachable and non-detachable storage devices), and/or a network accessible storage device, as non-limiting examples. System 800 includes an encoder/decoder module 830 configured, for example, to process data to provide an encoded video or decoded video, and the encoder/decoder module 830 can include its own processor and memory. The encoder/decoder module 830 represents module(s) that can be included in a device to perform the encoding and/or decoding functions. As is known, a device can include one or both of the encoding and decoding modules. Additionally, encoder/decoder module 830 can be implemented as a separate element of system 800 or can be incorporated within processor 810 as a combination of hardware and software as known to those skilled in the art.

Program code to be loaded onto processor 810 or encoder/decoder 830 to perform the various aspects described in this document can be stored in storage device 840 and subsequently loaded onto memory 820 for execution by processor 810. In accordance with various embodiments, one or more of processor 810, memory 820, storage device 840, and encoder/decoder module 830 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 810 and/or the encoder/decoder module 830 is used to store instructions and to provide working memory for processing that is needed during encoding or decoding. In other embodiments, however, a memory external to the processing device (for example, the processing device can be either the processor 810 or the encoder/decoder module 830) is used for one or more of these functions. The external memory can be the memory 820 and/or the storage device 840, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 800 can be provided through various input devices as indicated in block 805. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 6, include composite video.

In various embodiments, the input devices of block 805 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 800 to other electronic devices across USB and/or HDMI connections. It is to be understood that various aspects of input processing, for example, Reed-Solomon error correction, can be implemented, for example, within a separate input processing IC or within processor 810 as necessary. Similarly, aspects of USB or HDMI interface processing can be implemented within separate interface ICs or within processor 810 as necessary. The demodulated, error corrected, and demultiplexed stream is provided to various processing elements, including, for example, processor 810, and encoder/decoder 830 operating in combination with the memory and storage elements to process the data stream as necessary for presentation on an output device.

Various elements of system 800 can be provided within an integrated housing, Within the integrated housing, the various elements can be interconnected and transmit data therebetween using suitable connection arrangement 815, for example, an internal bus as known in the art, including the Inter-IC (12C) bus, wiring, and printed circuit boards.

The system 800 includes communication interface 850 that enables communication with other devices via communication channel 890. The communication interface 850 can include, but is not limited to, a transceiver configured to transmit and to receive data over communication channel 890. The communication interface 850 can include, but is not limited to, a modem or network card and the communication channel 890 can be implemented, for example, within a wired and/or a wireless medium.

Data is streamed, or otherwise provided, to the system 800, in various embodiments, using a wireless network such as a Wi-Fi network, for example IEEE 802.11 (IEEE refers to the Institute of Electrical and Electronics Engineers). The Wi-Fi signal of these embodiments is received over the communications channel 890 and the communications interface 850 which are adapted for Wi-Fi communications. The communications channel 890 of these embodiments is typically connected to an access point or router that provides access to external networks including the Internet for allowing streaming applications and other over-the-top communications. Other embodiments provide streamed data to the system 800 using a set-top box that delivers the data over the HDMI connection of the input block 805. Still other embodiments provide streamed data to the system 800 using the RF connection of the input block 805. As indicated above, various embodiments provide data in a non-streaming manner. Additionally, various embodiments use wireless networks other than Wi-Fi, for example a cellular network or a Bluetooth network.

The system 800 can provide an output signal to various output devices, including a display 865, speakers 875, and other peripheral devices 885. The display 865 of various embodiments includes one or more of, for example, a touchscreen display, an organic light-emitting diode (OLED) display, a curved display, and/or a foldable display. The display 865 can be for a television, a tablet, a laptop, a cell phone (mobile phone), or other device. The display 865 can also be integrated with other components (for example, as in a smart phone), or separate (for example, an external monitor for a laptop). The other peripheral devices 885 include, in various examples of embodiments, one or more of a stand-alone digital video disc (or digital versatile disc) (DVR, for both terms), a disk player, a stereo system, and/or a lighting system. Various embodiments use one or more peripheral devices 885 that provide a function based on the output of the system 800. For example, a disk player performs the function of playing the output of the system 800.

In various embodiments, control signals are communicated between the system 800 and the display 865, speakers 875, or other peripheral devices 885 using signaling such as AV.Link, Consumer Electronics Control (CEC), or other communications protocols that enable device-to-device control with or without user intervention. The output devices can be communicatively coupled to system 800 via dedicated connections through respective interfaces 865, 875, and 885. Alternatively, the output devices can be connected to system 800 using the communications channel 890 via the communications interface 850. The display 865 and speakers 875 can be integrated in a single unit with the other components of system 800 in an electronic device such as, for example, a television. In various embodiments, the display interface 865 includes a display driver, such as, for example, a timing controller (T Con) chip. The display 865 and speaker 875 can alternatively be separate from one or more of the other components, for example, if the RF portion of input 805 is part of a separate set-top box. In various embodiments in which the display 865 and speakers 875 are external components, the output signal can be provided via dedicated output connections, including, for example, HDMI ports, USB ports, or COMP outputs.

The embodiments can be carried out by computer software implemented by the processor 810 or by hardware, or by a combination of hardware and software. As a non-limiting example, the embodiments can be implemented by one or more integrated circuits. The memory 820 can be of any type appropriate to the technical environment and can be implemented using any appropriate data storage technology, such as optical memory devices, magnetic memory devices, semiconductor-based memory devices, fixed memory, and removable memory, as non-limiting examples. The processor 810 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, comprising inverse transform.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, transforming the image block into frequency domain. As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art. Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for transform. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into:
SDP (session description protocol), a format for describing multimedia communication sessions for the purposes of session announcement and session invitation, for example as described in RFCs and used in conjunction with RTP (Real-time Transport Protocol) transmission.
DASH MPD (Media Presentation Description) Descriptors, for example as used in DASH and transmitted over HTTP, a Descriptor is associated to a Representation or collection of Representations to provide additional characteristic to the content Representation.
RTP header extensions, for example as used during RTP streaming, and/or
ISO Base Media File Format, for example as used in OMAF and using boxes which are object-oriented building blocks defined by a unique type identifier and length also known as ‘atoms’ in some specifications.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Adapting the film grain process in the decoder and/or encoder.
Selecting a transform among core transforms to apply in a film grain simulating process in the decoder and/or in a film grain estimating process in the encoder.
Signaling an information relative to a film grain process to apply in the decoder.
Deriving an information relative to a film grain process to apply from a film grain information, the deriving being applied in the decoder and/or encoder.
Inserting in the signaling syntax elements that enable the decoder to identify the film grain process to use, such as transform types, transform sizes . . . .
Selecting, based on these syntax elements, the at least one transform type and transform size process to apply at the decoder.
A bitstream or signal that includes one or more of the described syntax elements, or variations thereof.
A bitstream or signal that includes syntax conveying information generated according to any of the embodiments described.
Inserting in the signaling syntax elements that enable the decoder to process film grain in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs a film grain process adapted to core transforms according to any of the embodiments described.
A TV, set-top box, cell phone, tablet, or other electronic device that performs a film grain process adapted to core transforms according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs a film grain process adapted to core transforms according to any of the embodiments described.
A TV, set-top box, cell phone, tablet, or other electronic device that receives (e.g. using an antenna) a signal over the air that includes an encoded image, and performs a film grain process adapted to core transforms according to any of the embodiments described.

1. A method comprising:
receiving film grain information that comprises at least one parameter that specifies an attribute of a film grain associated with an image block;
applying a transform to a block of random values, a transform being one of standardized core transforms, discrete cosine transform II (DCT-IIS, discrete cosine transform VIII (DCT-VIII), or discrete sine transform VII (DST-VII);
filtering the transformed block of random values, the filtering being defined by at least one parameter in the received film grain information; and
applying a respective inverse transform to the filtered transformed block of random values to generate a block of pixels with film grain pattern for the image block.

2. The method according to claim 1, wherein the one standardized core transform is DCT-II, wherein a size of the transform is N×M, wherein N is an integer in a range [2-64], and wherein M is an integer in a range [2-64].

3. The method according to claim 1, wherein the one standardized core transform is one of DCT-VIII and DST-VII, wherein a size of the transform is N×M, wherein N is an integer in a range [4-32], and wherein M is an integer in a range [4-32].

4-7. (canceled)

8. The method according to claim 1, wherein a same transform type and different transform sizes are used for luma and chroma components of the image block.

9. The method according to claim 1, wherein different transform types and a same transform size are used for luma and chroma components of the image block.

10. The method according to claim 1, wherein different transform types and different transform sizes are used for luma and chroma components of the image block.

11. The method according to claim 1, wherein the received film grain information further comprises at least one of:
an indication of a transform type used for luma component of the image block,
an indication of a transform size used for luma component of the image block,
an indication of a transform type used for chroma components of the image block,
an indication of a transform size used for chroma components of the image block,
an indication of a same transform type used for luma and chroma components of the image block,
an indication of a same transform size used for luma and chroma components of the image block, or
an indication on whether the luma transform type is inferred or not.

12. The method according to claim 11, wherein a transform type and a transform size used for chroma components of the image block are derived from the indication of a transform type for luma component of the image block and the indication of transform size for luma component of the image block.

13. The method according to claim 11, wherein a horizontal transform type and a vertical transform type are used for luma and chroma components of the image block, and wherein the horizontal transform type and the vertical transform type are different.

14. The method according to claim 1, to further comprising scaling at least one parameter that specifies an attribute of the film grain associated with the image block according to at least one of a standardized core transform size or a standardized core transform type used to generate the at least one parameter.

15-21. (canceled)

22. An apparatus comprising one or more processors, wherein the one or more processors are configured to:
receive film grain information that comprises at least one parameter that specifies an attribute of a film grain associated with an image block;
apply a transform to a block of random values, a transform being one of standardized core transforms, discrete cosine transform II (DCT-II), discrete cosine transform VIII (DCT-VIII), or discrete sine transform VII (DST-VII);
filter the transformed block of random values based on the at least one parameter in the received film grain information; and
apply a respective inverse transform to the filtered transformed block of random values to generate a block of pixels with film grain pattern for the image block.

23. The apparatus according to claim 22, wherein the one standardized core transform is DCT-II, wherein a size of the transform is N×M, wherein N is an integer in a range [2-64], and wherein M is an integer in a range [2-64].

24. The apparatus according to claim 22, wherein the one standardized core transform is one of DCT-VIII and DST-VII, wherein a size of the transform is N×M, wherein N is an integer in a range [4-32], and wherein M is an integer in a range [4-32].

25. The apparatus according to claim 22, wherein a same transform type and different transform sizes are used for luma and chroma components of the image block.

26. The apparatus according to claim 22, wherein different transform types and a same transform size are used for luma and chroma components of the image block.

27. The apparatus according to claim 22, wherein different transform types and different transform sizes are used for luma and chroma components of the image block.

28. The apparatus according to claim 22, wherein the received film grain information further comprises at least one of:
an indication of a transform type used for luma component of the image block,
an indication of a transform size used for luma component of the image block,
an indication of a transform type used for chroma components of the image block,
an indication of a transform size used for chroma components of the image block,
an indication of a same transform type used for luma and chroma components of the image block,
an indication of a same transform size used for luma and chroma components of the image block,
an indication on whether a luma transform type is inferred or not,
an indication on whether a chroma transform type is inferred or not,
an indication on whether a luma transform size is inferred or not, or
an indication on whether a chroma transform size is inferred or not.

29. The apparatus according to claim 28, wherein a transform type and a transform size used for chroma components of the image block are derived from the indication of a transform type for luma component of the image block and the indication of transform size for luma component of the image block.

30. The apparatus according to claim 28, wherein a horizontal transform type and a vertical transform type are used for luma and chroma components of the image block, and wherein the horizontal transform type and the vertical transform type are different.

31. The apparatus according to claim 22, further comprising scaling at least one parameter that specifies an attribute of the film grain associated with the image block according to at least one of a standardized core transform size or a standardized core transform type used to generate the at least one parameter.
